(19) United States
(12) Patent Application Publication
(10) Pub. No.: US 2020/0000264 A1
(43) Pub. Date: Jan. 2, 2020

(54) METHOD FOR OPERATING A COOKING DEVICE AND ASSEMBLY FOR CARRYING OUT THE METHOD

(71) Applicant: RATIONAL INTERNATIONAL AG, Heerbrugg (CH)

(72) Inventors: Markus LINGENHEIL, Wittenheim (FR); Jérôme DEIS, Wittenheim (FR)

(21) Appl. No.: 16/481,014

(22) PCT Filed: Jan. 23, 2018
(86) PCT No.: PCT/EP2018/051562

§ 371 Date: Jul. 25, 2019

(30) Foreign Application Priority Data
Jan. 25, 2017 (DE) 10 2017 101 407.1

(51) Int. Cl. A47J 27/14; A47J 37/12; A47J 27/08; A23L 5/10

(52) U.S. Cl. CPC A47J 27/14; A47J 37/1266; A23V 2002/00; A23L 5/11; A47J 27/0802

(57) ABSTRACT

Described is a method for operating a cooking appliance which has a cooking vessel to which a weight measuring system is assigned, wherein the weight of a substance introduced into the cooking vessel is determined via a weight difference determination and wherein the determined weight is used as a parameter for a safety function and/or a cooking process optimization, wherein the cooking process optimization comprises at least a time optimization, with the result that the duration of the cooking process is adapted to the weight of the introduced substance. Furthermore, an assembly is described.

The invention relates to a method for operating a cooking appliance, and an assembly with a weight measuring system and a cooking appliance.

Cooking appliances which are used in professional or commercial kitchens usually have a cooking vessel, into which a food to be cooked can be introduced. The cooking vessel can be a cooking chamber which can be sealed by means of a cooking chamber door. A particular type of cooking appliance has a cooking vessel formed as a pan, into which the food to be cooked can be introduced. The pan-like cooking vessels are suitable in particular for preparing liquids such as soups or for deep-frying foods to be cooked, wherein the frying oil is introduced into the cooking vessel.

To prepare dishes, the substances to be used, i.e. ingredients, water, food to be cooked, frying oil, etc., have to be provided in the desired quantity and added to the cooking vessel. For this, the various substances which are provided during the cooking process are usually first weighed using a separate set of scales in order to obtain the desired quantities. The substances are then introduced into the cooking vessel and prepared. For example, first the water with some ingredients is introduced and, during the cooking process, further ingredients, which in each case represent foods to be cooked.

In addition to merely determining quantities, care must also be taken when cooking food to adhere to certain safety regulations, which guarantee a smooth cooking process. This may involve, for example, not exceeding certain appliance-specific specifications, such as steam pressures in the case of steaming.

In addition, the efficiency of the cooking processes taking place with the cooking appliance is always to be designed to be more efficient or to be optimized by minimizing the energy consumption and/or the cooking time, for example.

From DE 10 2012 015 155 A1 a cooking appliance with a cooking vessel and weight detection is known, wherein the weight of the foodstuffs introduced into the cooking vessel is monitored in order, amongst other things, to indicate to the user a refilling of foodstuffs.

DE 101 20 136 A1 describes a cooking method and a cooking appliance, in which a food to be cooked placed on a cooking surface is detected by means of a weight sensor. A heating unit assigned to the position of the food to be cooked on the cooking surface is correspondingly actuated.

From DE 103 53 299 A1 a cooking pot is known which can be positioned on a conventional cooktop in the form of a hotplate, which has a weight measuring system.

The object of the invention is to operate a cooking appliance as efficiently and safely as possible, with the result that the cooking processes can be carried out in an optimized manner.

The object is achieved according to the invention by a method for operating a cooking appliance which has a cooking vessel to which a weight measuring system is assigned, wherein the weight of a substance introduced into the cooking vessel is determined via a weight difference determination and wherein the determined weight is used as a parameter for a safety function and/or a cooking process optimization, wherein the cooking process optimization comprises at least a time optimization, with the result that the duration of the cooking process is adapted to the weight of the introduced substance.

The basic idea of the invention is that a weight measuring system is assigned to the cooking vessel itself, with which the weight or the quantity of an introduced substance can be determined in a simple manner. For this, a weight difference determination is taken into account, which means that the increase in the weight which results when the cooking vessel is filled with a substance is determined. Accordingly, the quantity or the weight of the introduced substance can be inferred therefrom, wherein the quantity or the weight of the substance is used as a parameter for a safety function and/or a cooking process optimization which comprises at least a time optimization, with the result that the cooking process can be operated in an efficient manner and safely. The quantity of the introduced substance can be inferred from the recorded weight. The larger the quantity of the introduced substance, in particular of a food to be cooked, or the weight thereof, the longer the cooking duration may be. It is thus guaranteed that the cooking time is optimized for the recorded quantity or the weight of the introduced substance, in order to obtain an optimal cooking result.

Because the weight measuring system is assigned to the cooking vessel, the quantity or the weight of the substance can be determined irrespective of any lid position. The weight difference determination provides that the weight of the cooking appliance is first determined and this is subtracted from the total weight once the substance has been introduced into the cooking vessel, with the result that the tare or tare weight can be determined. The weight difference determination can therefore also be referred to as the tare weight determination.

One aspect provides that the substance is water, oil or food to be cooked. Depending on the desired cooking process, another substance can be introduced into the cooking vessel, since, for example, in the case of a soup, water is first admitted into the cooking vessel, the quantity or weight of which can be correspondingly recorded via the weight difference determination. Alternatively, a food to be cooked consisting of solid matter can be introduced into the cooking vessel, which is for example browned in the cooking vessel. The quantity of the food to be cooked can also be determined via the weight difference determination. By substance is meant all of the ingredients provided for a cooking process, thus also spices or the like, even if they are to be removed again before serving the prepared dish.

A further aspect provides that the determined weight of the introduced substance is displayed. As a result, the user of the cooking appliance can learn directly how large the quantity or the weight of the introduced substance is, with the result that they can easily check whether the desired quantity has already been introduced.

In particular, the quantity of the introduced substance is determined, with the result that the portioning of the substance is simplified. The individual ingredients for a cooking process, in particular water and/or food to be cooked, can thus be portioned in a simple manner and reliably in the cooking appliance itself. The separate weighing step, which is otherwise usually carried out using an external set of scales, is thus dispensed with. Accordingly, the cooking process is designed to be more efficient or is optimized.

According to a further aspect, the determined weight of the introduced substance is used for an automated cooking process optimization. According to this, a control system of the cooking appliance accesses the weight measuring system, wherein it receives the starting values from the weight measuring system as input parameters, on the basis of which the cooking process and/or the cooking appliance is controlled. Depending on the obtained weight which was measured by the weight measuring system, the control system of the cooking appliance can optimize a cooking process to be executed. This ensures that operating errors by the operator are avoided, since the cooking appliance, in particular the control system, automatically adapts the corresponding cooking process parameters to the determined quantity or the determined weight of the introduced substance. The cooking appliance is thus equipped with additional intelligence since it can adapt parameters of the cooking process during the cooking process, thus live.

These can be fill levels, which are recorded and monitored by means of the weight difference determination, in particular by the control system. The recorded and monitored fill levels can relate to the food to be cooked itself or an auxiliary cooking medium, for example water, fat and/or oil.

In accordance with the monitoring of the fill levels, a message can be issued to the operator that a substance should be refilled. The substance is, for example, an auxiliary cooking medium.

In particular, the cooking process can be optimized to the effect that variable fill levels of the substances are provided during the cooking process. In this respect the cooking appliance can (even automatically) refill substances during operation, in particular an auxiliary cooking medium such as water.

In general a cooking process optimization may also be that a reduction in weight of the food to be cooked is recorded via the weight difference determination, in particular during the cooking process taking place. For example, in the cooking of certain foods a loss in weight of the food to be cooked is not desired. The cooking process is therefore optimized such that the food to be cooked is cooked without or with a very slight loss in weight. For example, the temperature is reduced during the cooking in order to counteract the loss in weight that occurs.

A further example is that the point in time when a sauce has been reduced to the desired extent is established, which also represents a cooking process optimization. On the basis of the determined reduction in weight the cooking appliance thus receives the information as to whether the sauce has the desired consistency. The cooking process is then stopped with the sauce at the desired consistency, so that there is an optimized cooking result.

Moreover, a reduction in weight of the substances located in the cooking vessel, in particular of the food to be cooked, can be established via the weight difference determination. This is important for example for portioning dishes, as it can be correspondingly checked that the same or substantially the same quantity by weight is always removed from the cooking vessel. Thus the different portions are substantially the same size.

In general the determined reduction in weight of the food to be cooked and/or of the auxiliary cooking media, i.e. of the substances present in the cooking vessel, can be used as a parameter for the optimization of the cooking process. For example, adjustments are made automatically on the cooking appliance on the basis of the recorded reduction in weight, or suggested to the operator of the cooking appliance. The adjustments can be altered heat outputs.

In particular, the determined weight of the substance is used for the heating temperature optimization of the cooking process. The heating temperature can be correspondingly adapted, as a lower heat output may be sufficient in the case of a smaller quantity. The heating temperature optimization represents one aspect of the cooking process optimization.

The cooking time and the heating temperature can be automatically adapted by the control system, with the result that an automated cooking process takes place.

The time optimization and/or the heating temperature optimization of the cooking process can also be used in the case of a cooking process in which the food to be cooked has unintentionally lost (a lot of) weight. The heating temperature and/or the cooking time are or is consequently adapted.

Furthermore, the distribution of the substance in the cooking vessel can be determined, with the result that heating elements assigned to the cooking vessel are actuated according to the determined distribution of the substance. This results in an improvement in the performance management of the cooking appliance in operation, as only the heating elements to which food to be cooked is also actually assigned are actuated. An inefficient heating of the whole cooking vessel is thus avoided. For this purpose the weight measuring system has several weight sensors, for example, which are arranged distributed and are assigned to the cooking vessel, with the result that a corresponding weight distribution of the introduced substance in the cooking vessel can be determined. This embodiment variant is important in particular for foods to be cooked in solid form, as they can be distributed unevenly in the cooking vessel. The energy consumption of the cooking appliance can thus be lowered, whereby the efficiency correspondingly increases.

A further variant provides that the quantity of the introduced substance is determined, with the result that an operation of the cooking appliance under pressure or as a deep fryer is made safe. Here, the determined weight or the determined quantity is used as a safety parameter. For example, the quantity of water hi the case of an operation of the cooking appliance under pressure represents a safety-relevant parameter, because with too large a quantity of water too high a pressure could be bunt up, whereby the safety of the cooking appliance during the cooking process would no longer be guaranteed. This applies analogously to the introduced quantity of frying oil or frying fat, which in operation of the cooking appliance as a deep fryer also represents a safety-relevant parameter. If the weight measuring system establishes that the safety-relevant parameter, i.e. the introduced quantity of water or frying oil/fat, exceeds a threshold value, a warning can be issued and/or the cooking appliance can be shut down.

A further safety function relates to the fill levels, as overfilling can be avoided, The cooking appliance, in particular the control system thereof, can automatically shut off a water intake of the cooking appliance if it was established via the weight difference determination that the cooking vessel has already been filled. For this purpose a threshold value with respect to the weight difference determination can be stored in the control system; when it is reached or exceeded the water intake is shut off. Alternatively or in addition to this, a warning can first be issued to the operator of the cooking appliance that the cooking vessel is in danger of being overfilled. This warning can again be issued if a (different) threshold value has been reached or exceeded. For example, two different threshold values are thus stored in the control system.

Moreover, recipes can be carried out more easily as the quantities of the individual substances, which the recipe stipulates, can be measured out directly in the cooking vessel via the weight difference determination. This is generally also referred to as the so-called tare function. The individual substances can be auxiliary cooking media such as water, oil and/or fat or the food to be cooked itself.

Recipes can also be programmed and/or edited in a simple manner in that the weighed quantity of a substance which serves as ingredient for the corresponding recipe is programmed in as a target value or the target value existing in the recipe is transferred over. The programming can be effected in the cooking appliance or the weight measuring system, in particular the corresponding control system.

Furthermore, the object is achieved according to the invention by an assembly, with a weight measuring system and a cooking appliance, which has a control system, which is set up to carry out a method of the above-named type. Accordingly, with the assembly it is possible to operate a cooking process in an efficient and safe manner.

According to one aspect, the weight measuring system is integrated in an intermediate frame on which the cooking appliance is arranged, in particular wherein the weight measuring system has several individual weight sensors which are arranged distributed. Accordingly, conventional cooking appliances without a weight measuring system can be used, which are assigned to the intermediate frame, in particular are placed on it. The intermediate frame is placed on a base frame, for example a table, or a plinth, on which the cooking appliance would otherwise be placed. The weight measuring system, which monitors the weight of the cooking vessel of the cooking appliance in an efficient manner and determines the weight or the quantity of an introduced substance via a weight difference determination, in particular the distribution in the cooking vessel, is integrated in the intermediate frame. The individual weight sensors can be formed in a simple manner as strain gauges. The intermediate frame can be manufactured from stainless steel, for example can be realized as an edged or deep-drawn part.

With the base frame the intermediate frame can form a unit which also comprises a drawer element, for example. In this assembly, the cooking appliance is placed on the intermediate frame which is then standing on the floor.

In general, the cooking appliance is set up to carry out a cooking process, the course of which is automatically controlled by the control system. In other words, the control system is set up to automatically control the course of the cooking process.

A cooking process is therefore carded out by the cooking appliance, wherein the course of the cooking process is automatically controlled by the control system.

The cooking appliance comprises in particular the control system and the cooking vessel.

The control system and the cooking vessel can be assigned to a common housing, for example a cooking appliance housing.

The control system and the cooking vessel can be enclosed by the common housing, in particular wherein the housing encloses a technical area, in which the control system is accommodated, and the cooking vessel.

Further advantages and properties of the invention are revealed by the following description and the drawings, to which reference is made. In the drawings, there are shown in:

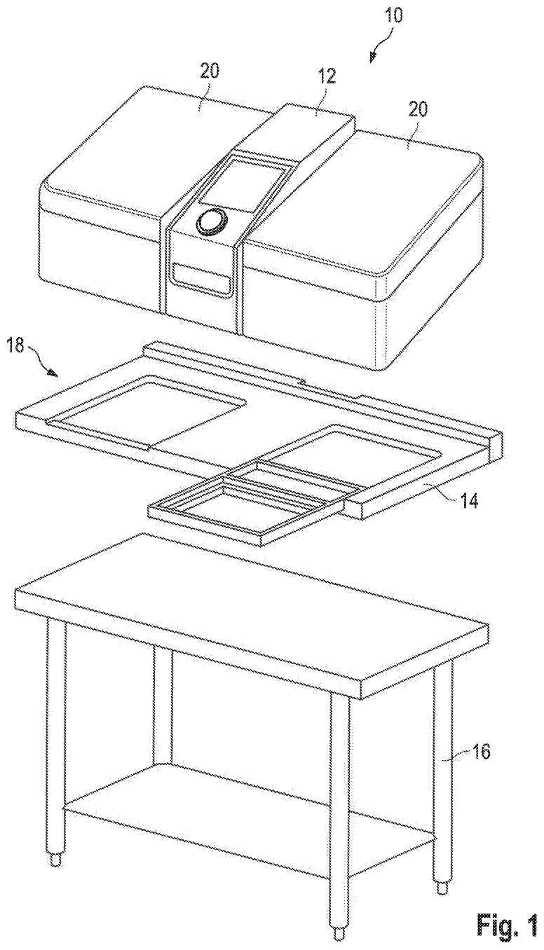

FIG. 1 a schematic exploded view of an assembly according to the invention according to a first embodiment,

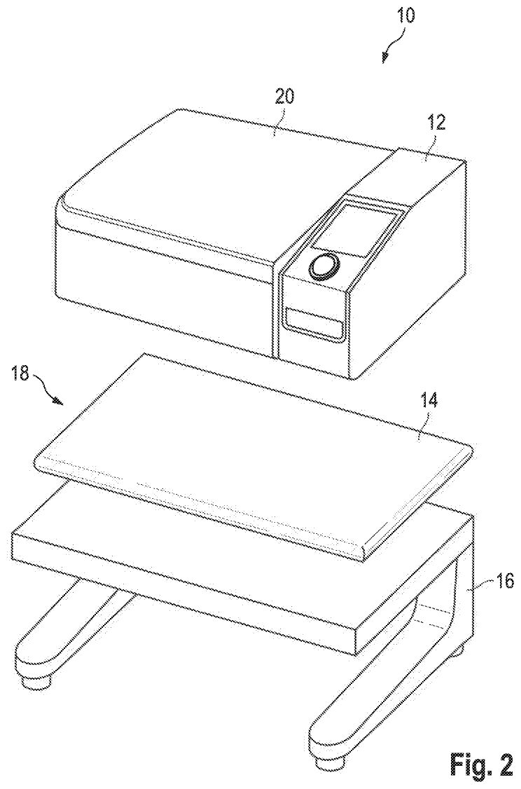

FIG. 2 a schematic exploded view of an assembly according to the invention according to a second embodiment,

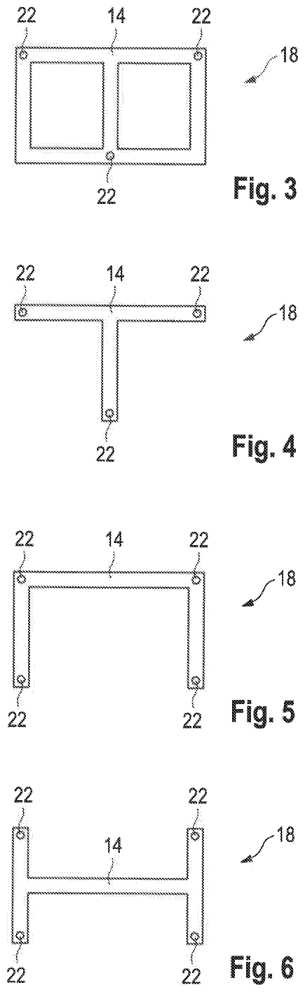

FIG. 3 a schematic representation of the distribution of the weight sensors in an intermediate frame according to a first embodiment,

FIG. 4 a schematic representation of the distribution of the weight sensors in an intermediate frame according to a second embodiment,

FIG. 5 a schematic representation of the distribution of the weight sensors in an intermediate frame according to a third embodiment, and

FIG. 6 a schematic representation of the distribution of the weight sensors in an intermediate frame according to a fourth embodiment.

FIG. 1 schematically shows an assembly 10, which has a cooking appliance 12, an intermediate frame 14 and a base frame 16 formed as a table.

The base frame 16 is placed on a floor in a room in which the cooking appliance 12 is to be operated. The intermediate frame 14, which comprises a weight measuring system 18, is arranged on a surface of the base frame 16.

In turn the cooking appliance 12, which can be formed conventionally, is placed on the intermediate frame 14, with the result that the cooking appliance 12 is arranged above the intermediate frame 14 on the base frame 16. The intermediate frame 14 is thus arranged sandwich-like between the base frame 16 and the cooking appliance 12.

The cooking appliance 12 has, as is usual, a cooking vessel 20, wherein the cooking appliance 12 according to the embodiment shown in FIG. 1 has two separate cooking vessels 20, to each of which the weight measuring system 18 is assigned. The cooking vessels 20 are pan-shaped cooking vessels, as are usually provided in a pan cooking appliance, to each of which a lid is assigned.

As an alternative to the embodiment shown, the assembly 10 can merely consist of the cooking appliance 12 and the intermediate frame 14 which extends down to the floor. According to this embodiment, the intermediate frame 14 simultaneously also forms the base frame 16. In this embodiment variant, a supporting surface is also provided for the cooking appliance 12, to which the weight measuring system 18 is assigned, with the result that the weight of the cooking appliance 12 can be determined.

Furthermore, the weight measuring system 18 can also be integrated in the cooking appliance 12 itself, with the result that the cooking appliance 12 merely has to be placed on a conventional table or base frame 16.

Irrespective of the embodiment, the weight measuring system 18 is formed in such a way that it carries out a weight difference determination in order to determine how large the weight or the quantity of a substance introduced into the cooking vessel 20 is. The introduced substance can be food to be cooked or an auxiliary cooking medium, for example water, oil and/or fat. The weight measuring system 18 thus determines the tare, in that first the weight of the cooking appliance 12 is determined and this is compared with the total weight of the cooking appliance 12 and of the substance introduced into the cooking vessel 20, wherein the weight of the introduced substance is correspondingly determined via the difference.

The weight determined by the weight measuring system 18 can then be used as a parameter for a safety function and/or a cooking process optimization, as is explained below.

For example, a soup is to be prepared with the assembly 10 shown in FIG. 1, for which water is first added to the cooking vessel 20. The quantity of the water can be determined directly on the cooking appliance 12 here, as the weight measuring system 18 is assigned to the cooking vessel 20. First, the weight of the cooking appliance 12 and then the weight of the cooking appliance 12 with the water introduced into the cooking vessel 20 was determined, so that the two determined weights are subtracted from each other in order to determine the tare, i.e. the weight of the introduced water.

The use of the cooking appliance 12 as well as the operation of the cooking appliance 12 is correspondingly simplified, as the user of the cooking appliance 12 can determine directly on site how much water they have already introduced into the cooking vessel 20. Thus they need not first determine the quantity of water separately.

The assembly 10 has a display via which the corresponding information of the determined weight can be displayed to the operator. If only the cooking appliance 12 has a corresponding display surface, the weight measuring system 18 is connected to the cooking appliance 12 in order to transfer the corresponding data.

In an analogous manner, the weight of an introduced substance such as a food to be cooked can thus be determined, so that the quantity of the food to be cooked is determined on site. The operator of the cooking appliance 12 thus receives the information which is relevant for the portioning on site.

Moreover, the determined weight can be transmitted to a control system of the cooking appliance 12, with the result that the cooking appliance 12 or a cooking process to be carried out with the cooking appliance 12 is carried out in an automated manner. Correspondingly, for example a heat output and/or the cooking duration of the cooking process is automatically adapted to the determined weight of the introduced substance, in particular of the food to be cooked. The intermediate frame 14 and the cooking appliance 12 are thus electrically coupled to each other.

The cooking appliance 12 is thus set up to adapt parameters relevant to the cooking process during the cooking process, on the basis of the weight difference determination carried out. The parameters can be the heat output and/or the cooking duration, but also the introduced substances, for example the auxiliary cooking media.

Correspondingly, fill levels of the substances can be recorded and monitored by means of the weight difference determination. The control system, which receives the corresponding data, can then send a warning or message to the user that the recorded fill level is critical. The critical state can be a fill level that is too low, which is not optimal for the cooking result, or a fill level that is too high, at which there is a danger of overflowing. Both cases can be recorded by means of corresponding threshold values stored in the control system of the cooking appliance 12. Reaching or exceeding the threshold value can result in a warning or message being issued to the operator, so that they can manually intervene.

Refilling of a particular substance, for example water, can he provided as a message. The cooking process is correspondingly optimized, as variable fill levels during the cooking process are possible. The refilling can also he effected in an automated manner, in that for example water is supplied via the water intake.

Alternatively or in addition, a second threshold value is provided, in the case of which a safety function is triggered, for example. This can be the automatic shutting off of a water intake, so that overfilling of the cooking vessel is effectively prevented.

Furthermore, the determined weight of the introduced substance can serve as a parameter of a safety function, for example in the case of operation of the cooking appliance 12 for steaming.

Here, an introduced quantity of water can be determined in an analogous manner, which however is regarded and thus processed as a safety-relevant parameter by the cooking appliance 12, as with too large a quantity of water too high a pressure could be built up, which would impair the safe operation of the cooking appliance 12.

The weight measuring system 18 is in particular coupled to the cooking appliance 12, for example to a control system of the cooking appliance 12, with the result that the cooking process cannot be started because there is a safety-relevant problem. The user of the cooking appliance 12 is again informed about this by means of the display.

Furthermore, a quantity of frying oil/fat can be used as a safety-relevant parameter, for example in the case of an operation of the cooking appliance 12 as a deep fryer. If the user of the cooking appliance 12 has chosen a cooking process in which the cooking appliance 12 is to be operated as a deep fryer, the quantity of the frying oil/fat introduced into the cooking vessel 20 is determined. If the quantity exceeds a threshold value, the cooking appliance 12 can be shut down and/or a warning can be issued to the user.

In addition, a cooking process optimization may be that the reduction in weight of the food to be cooked is determined during the cooking process, thus live. The reduction in weight is correspondingly recorded via the weight difference determination. In certain foods to be cooked a reduction in weight is not desired, with the result that the cooking process parameters can be correspondingly adapted in order to avoid a further loss in weight. For example, the heat output is reduced.

Moreover, the optimal point in time of cooking can be determined via the determined reduction in weight of the food to be cooked. For example in the reduction of a sauce or the like. Correspondingly, it can be recorded when the food to be cooked has the desired consistency.

In general, the reduction in weight of the food to be cooked and/or of the auxiliary cooking media, thus of the substances present in the cooking vessel 20, occurring during the cooking process can be used as a parameter for the cooking process optimization. For example, adjustments are made automatically on the cooking appliance 12 on the basis of the recorded reduction in weight, or corresponding adjustments are suggested to the operator of the cooking appliance 12. The adjustments can be altered heat outputs and/or cooking durations.

Furthermore, recipes can be carried out more easily with the cooking appliance 12 as the corresponding quantities of the individual substances poured into the cooking vessel 20 can be measured directly in the cooking vessel 20 via the weight difference determination. This procedure is referred to as the so-called tare function. The individual substances poured into the cooking vessel 20 can be auxiliary cooking media such as water, oil and/or fat or the food to be cooked itself.

Moreover, recipes can be programmed and/or edited in a simple manner in that the weighed quantity of a substance introduced into the cooking vessel 20, which serves as ingredient for the corresponding recipe, is programmed in as a target value or the target value existing in the recipe is transferred over. The programming can be effected in the cooking appliance 12 or the weight measuring system, in particular the corresponding control system.

FIG. 2 shows an assembly 10 according to a second embodiment, in which the intermediate frame 14 is formed over the whole surface.

The intermediate frame 14 represents a mat on which the cooking appliance 12 is placed. The intermediate frame 14 formed as a mat is laid on a supporting surface of the base frame 16, on which the cooking appliance 12 would usually be placed.

In an analogous manner to the first embodiment, the intermediate frame 14 comprises the weight measuring system 18, so that it is possible to determine the weight or the quantity of a substance introduced into the cooking vessel 20 via a weight difference determination.

FIGS. 3 to 6 show embodiment variants of the intermediate frame 14, in which the weight measuring system 18 has different structures. Furthermore, the intermediate frames 14 themselves also have different shapes.

It is also evident from FIGS. 3 to 6 that the weight measuring system 18 comprises several weight sensors 22 which are arranged distributed in the respective intermediate frame 14. It is evident from the figures that for example three or four weight sensors 22 are integrated in the respective intermediate frame 14. However, the exact number can vary.

The weight sensors 22 are distributed such that the distances between them are as large as possible. This means that it is possible for not only the total weight of the introduced substance to be determined via the weight difference determination, but also the distribution thereof in the cooking vessel 20. This is advantageous in particular if the introduced substance, for example a food to be cooked, is solid matter.

Accordingly, it can be determined at which points the food to be cooked has been introduced into the cooking vessel 20, thus the points at which food to be cooked is present in the cooking vessel 20.

Heating elements assigned to these points can then be correspondingly actuated differently, in order to cook the food to be cooked. Thus, for example, a heating element which is assigned to a small quantity of food to be cooked is heated less strongly than a heating element which is assigned to a large quantity of food to be cooked. If there are points at which no food to be cooked at all was introduced, the correspondingly assigned heating elements may not be switched on.

This means that the cooking appliance 12 can be operated in an efficient manner as heating elements to which no food to be cooked is assigned need not be switched on, or the heating elements are operated in an optimized manner.

The weight sensors 22 can be formed as strain gauges or piezoelectric sensors, via which the weight can be correspondingly determined.

The intermediate frame 14 can be formed from stainless steel, in particular as an edged or deep-drawn part.

Due to the weight difference determination of the introduced substance and the use of the determined weight as a parameter, it is ensured according to the invention that a cooking process operated with the cooking appliance 12 can be operated efficiently and in an optimized manner.

1: A method for operating a cooking appliance which has a cooking vessel to which a weight measuring system is assigned, wherein a weight of a substance introduced into the cooking vessel is determined via a weight difference determination and wherein the determined weight is used as a parameter for a safety function and/or a cooking process optimization, wherein the cooking process optimization comprises at least a time optimization, with the result that a duration of the cooking process is adapted to the weight of the introduced substance.

2: The method according to claim 1, wherein the substance is water, oil or food to be cooked.

3: The method according to claim 1, wherein the determined weight of the introduced substance is displayed.

4: The method according to claim 1, wherein a quantity of the introduced substance is determined, with the result that a portioning of the food to be cooked is simplified.

5: The method according to claim 1, wherein the determined weight of the introduced substance is used for an automated cooking process optimization.

6: The method according to claim 1, wherein the determined weight of the substance is used for a heating temperature optimization of the cooking process.

7: The method according to claim 1, wherein a distribution of the substance in the cooking vessel is determined, with a result that heating elements assigned to the cooking vessel are actuated according to the determined distribution of the substance.

8: The method according to claim 1, wherein a quantity of the introduced substance is determined, with the result that an operation of the cooking appliance under pressure or as a deep fryer is made safe.

9: An assembly with a weight measuring system and a cooking appliance, which has a control system, which is set up to carry out a method according to claim 1.

10: An assembly according to claim 9, wherein the weight measuring system is integrated in an intermediate frame on which the cooking appliance is arranged, in particular wherein the weight measuring system has several individual weight sensors which are arranged distributed.

11: The method according to claim 2, wherein the determined weight of the introduced substance is displayed.

12: The method according to claim 2, wherein a quantity of the introduced substance is determined, with the result that a portioning of the food to he cooked is simplified

13: The method according to claim 2, wherein the determined weight of the introduced substance is used for an automated cooking process optimization.

14: The method according to claim 2, wherein the determined weight of the substance is used for the heating temperature optimization of the cooking process.

15: The method according to claim 2, wherein a distribution of the substance in the cooking vessel is determined, with a result that heating elements assigned to the cooking vessel are actuated according to the determined distribution of the substance.

16: The method according to claim 2, wherein a quantity of the introduced substance is determined, with the result that an operation of the cooking appliance under pressure or as a deep fryer is made safe.

17: The method according to claim 3, wherein a quantity of the introduced substance is determined, with the result that a portioning of the food to be cooked is simplified.

18: The method according to claim 3, wherein the determined weight of the introduced substance is used for an automated cooking process optimization.

19: The method according to claim 3, wherein the determined weight of the substance is used for the heating temperature optimization of the cooking process.

20: The method according to claim 3, wherein a distribution of the substance in the cooking vessel is determined, with a result that heating elements assigned to the cooking vessel are actuated according to the determined distribution of the substance.
